(19) United States
(12) Patent Application Publication
(10) Pub. No.: US 2012/0270070 A1
(43) Pub. Date: Oct. 25, 2012

(54) HYBRID COPPER ALLOY REALIZING SIMULTANEOUSLY HIGH STRENGTH, HIGH ELASTIC MODULUS, HIGH CORROSION-RESISTANCE, WEAR RESISTANCE, AND HIGH CONDUCTIVITY AND MANUFACTURING METHOD THEREOF

(75) Inventors: Sun Ig HONG, Daejeon (KR); Ki Hwan OH, Daejeon (KR)

(73) Assignee: The Industry & Academic Coorporation in Chungnam National University (IAC), Daejeon (KR)

(21) Appl. No.: 13/367,457

(22) Filed: Feb. 7, 2012

(30) Foreign Application Priority Data
Apr. 22, 2011 (KR) 10-2011-0037777

(51) Int. Cl. B32B 15/20; C22F 1/00; B22D 19/00

(52) U.S. Cl. 428/675; 228/101; 164/99; 148/522

(57) ABSTRACT

Disclosed are a hybrid copper alloy with high strength, high elastic modulus, high corrosion-resistance, wear resistance, and high conductivity and a method for producing the same.

The hybrid copper alloy has a bi- or multi-layer structure in which (A) a copper alloy Cu (A) selected from the group consisting of Cu—Zn, Cu—Al, Cu—Ni—Zn, Cu—Ni—Si, Cu—Ni—Sn and Cu—Ni—Si—Sn is bonded to a copper alloy Cu (B) selected from the group consisting of Cu—Cr, Cu—Zr, Cu—Ag, Cu—Mg and Cu—Cr—Zr or molten alloys of a copper alloy Cu (A) and a copper alloy Cu (B) are cast in parallel such that a joint interface between these alloys is present.

The hybrid copper alloy exhibits high strength, high elasticity, high corrosion resistance, abrasion resistance and high conductivity that cannot be obtained by a single copper alloy known to date.

### BACKGROUND OF THE INVENTION

1. Field of the Invention

The present invention relates to a copper alloy and a method for producing the same. More particularly, the present invention relates to a hybrid copper alloy that can exhibit high strength, high elastic modulus, high corrosion-resistance, wear resistance, and high conductivity by bonding two types of copper alloys in which a variety of metallic elements are added to a copper matrix and a method for producing the same.

2. Description of the Related Art

Copper alloys generally have a higher conductivity than other metals and are thus widely used in various industrial fields due to this property.

In accordance with recent rapid development in electrical, information, communication and automobile industries and the like, corrosion resistance, abrasion resistance and high strength as well as high conductivity are required for copper alloys.

Generally, increasing conductivity of copper alloys can be achieved at the expense of strength. That is, when alloying elements are added in order to increase strength, conductivity is deteriorated due to the electronic scattering. In order to solve these problems, that is, to realize both conductivity and strength, a variety of research has been conducted and recently, precipitation-hardened copper alloys containing the second phase particles such as Cu—Cr alloys, Cu—Ag alloys, Cu—Zr alloys, Cu—Cr—Zr alloys are known as copper alloys with both high conductivity and high strength.

When high strength and high conductivity, as well as heat resistance, corrosion resistance, high elasticity, abrasion resistance and the like are required, it is impossible to design and prepare an alloy that satisfies all these requirements. Accordingly, clad or hybrid alloys obtained through bonding of metals having various properties, clad or hybrid alloys with multifunctional properties, multifunctional alloys and the like were developed and used. For example, Al/Mg clad materials obtained through bonding of Al and Mg, Ti/STS clad materials obtained through bonding of Ti and STS, Cu/Fe clad materials obtained through bonding of Cu and Fe and the like are used.

### SUMMARY OF THE INVENTION

The conventional copper alloys known to date do not exhibit the combination of satisfactory strength, good abrasion resistance, excellent corrosion resistance and high elasticity, while maintaining high conductivity.

That is, through addition of various alloying elements, some properties can be improved at the expense of others, and all required properties cannot be satisfied. Therefore, it is difficult to satisfy the required properties using a single Cu alloy.

The present invention has been made in view of the above problems, and it is an object of the present invention to provide a hybrid copper alloy material that exhibits high strength, high elasticity, high corrosion resistance, abrasion resistance and high conductivity by bonding two types of copper alloys or jointly casting two copper alloys in parallel in which various metallic elements are selectively added to each copper matrix and a method for producing the same.

In accordance with the present invention, the above and other objects can be accomplished by the provision of a hybrid copper alloy in which (A) a copper alloy Cu (A) selected from the group consisting of Cu—Zn, Cu—Al, Cu—Ni—Zn, Cu—Ni—Si, Cu—Ni—Sn, Cu—Ni—Si—Sn is bonded to a copper alloy Cu (B) selected from the group consisting of Cu—Cr, Cu—Zr, Cu—Ag, Cu—Mg and Cu—Cr—Zr in the form of a bi- or multi-layer or a copper alloy Cu (A) and a copper alloy Cu (B) are jointly cast in parallel such that a joint interface between two alloys is present.

In the copper alloy Cu (A), preferably, the composition range of Cu—Zn is 0.1 to 35 wt % of Zn, the composition range of Cu—Al is 0.1 to 20 wt % of Al, the composition range of Cu—Ni—Zn is (0.1 to 20 wt %)Ni-(0.1 to 25 wt %)Zn, the composition range of Cu—Ni—Si is (0.1 to 20 wt %)Ni-(0.1 to 15 wt %)Si, the composition range of Cu—Ni—Sn is (0.1 to 20 wt %)Ni-(0.1 to 15 wt %) Sn, the composition range of Cu—Ni—Si—Sn is (0.1 to 20 wt %)Ni-(0.1 to 15 wt %) Si-(0.1 to 15 wt %) Sn, and the balance of the respective alloys is Cu containing inevitable impurities.

In the copper alloy Cu(B), preferably, the composition range of Cu—Cr is 0.01 to 15 wt % of Cr, the composition range of Cu—Zr is 0.01 to 5 wt % of Zr, the composition range of Cu—Ag is 0.01 to 25 wt % of Ag, the composition range of Cu—Mg is 0.001 to 5 wt % of Mg, the composition range of Cu—Cr—Zr is (0.01 to 15 wt %) Cr-(0.01 to 5 wt %) Zr and the balance of the respective alloys is Cu containing inevitable impurities.

In accordance with another aspect, provided is a method for producing a copper alloy including: (a) preparing one copper alloy Cu(A) selected from the group consisting of Cu—Zn, Cu—Al, Cu—Ni—Zn, Cu—Ni—Si, Cu—Ni—Sn and Cu—Ni—Si—Sn, or a molten alloy thereof; (b) preparing one copper alloy Cu(B) selected from the group consisting of Cu—Cr, Cu—Zr, Cu—Ag, Cu—Mg and Cu—Cr—Zr, or a molten alloy thereof; and (c) laminating the copper alloy Cu(A) and the copper alloy Cu(B) in the form of a bi- or multi-layer, followed by bonding, or casting a molten alloy of the molten copper alloy Cu(A) and a molten alloy of the molten copper alloy Cu(B) in parallel such that a joint interface between these alloys is present.

The method may further include: subjecting at least one copper alloy of the copper alloy Cu(A) and the copper alloy Cu(B) or cast hybrid alloy to heat treatment at a temperature range of 200 to 1100° C., before step (c).

The method may further include: aging the hybrid copper alloy obtained by laminating and bonding the copper alloy Cu(A) and the copper alloy Cu(B), or the hybrid copper alloy obtained by casting the molten copper alloy Cu(A) and the molten copper alloy Cu(B) in parallel at a temperature of 25 to 650° C., after step (c).

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating a copper alloy composed of Cu(A)-Cu(B) according to one embodiment of the present invention;

FIG. 2 is a schematic view illustrating a copper alloy composed of Cu(A)-Cu(B)-Cu(A) according to another embodiment of the present invention;

FIG. 3 is a schematic view illustrating a copper alloy composed of Cu(A)-Cu(B)-Cu(A)-Cu(B)-Cu(A) according to another embodiment of the present invention;

FIG. 4 is an image showing a hybrid copper alloy produced in Example 1 (×200); and

FIG. 5 is an image showing a hybrid copper alloy produced in Example 4 (×200).

### DETAILED DESCRIPTION OF THE INVENTION

Hereinafter, the present invention will be described in more detail.

First, the present invention provides a hybrid copper alloy that can simultaneously exhibit high strength, high elasticity, high corrosion resistance, abrasion resistance and high conductivity. The hybrid copper alloy according to one embodiment of the present invention is provided in the form of a bi- or multi-layer containing: one copper alloy Cu(A) selected from the group consisting of Cu—Zn, Cu—Al, Cu—Ni—Zn, Cu—Ni—Si, Cu—Ni—Sn and Cu—Ni—Si—Sn, and one copper alloy Cu(B) selected from the group consisting of Cu—Cr, Cu—Zr, Cu—Ag, Cu—Mg and Cu—Cr—Zr.

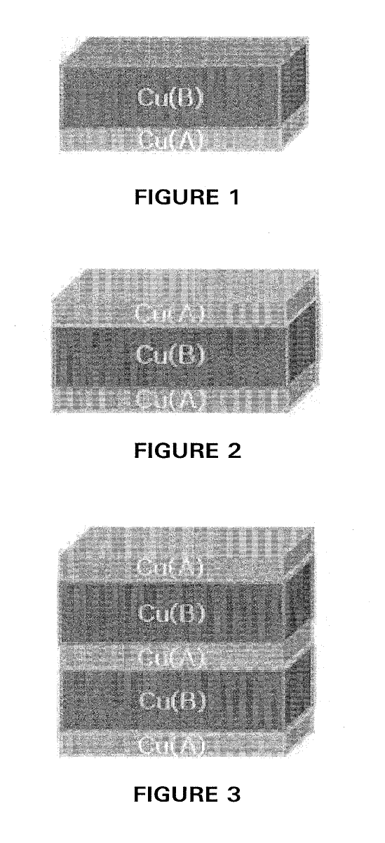

That is, the copper alloy according to the present invention, as shown in FIGS. 1 to 3, contains a copper alloy Cu(A) and a copper alloy Cu(B) as one selected from various structures of Cu(A)-Cu(B), Cu(A)-Cu(B)-Cu(A), Cu(A)-Cu(B)-Cu(A)-Cu(B)-Cu(A) and the like. The structures of the invented hybrid copper alloys include, but are not limited to these exemplified structures.

The bonding of the copper alloy Cu(A) to the copper alloy Cu(B) may be carried out by various methods, that is, by preparing a copper alloy Cu(A) and a copper alloy Cu(B), and laminating and bonding the copper alloys; directly casting a molten alloy of the copper alloy Cu(A) and a molten alloy of the copper alloy Cu(B) in parallel; or the like.

Regarding the copper alloy Cu(A), preferably, the composition range of Cu—Zn is 0.1 to 35 wt % of Zn, the composition range of Cu—Al is 0.1 to 20 wt % of Al, the composition range of Cu—Ni—Zn is (0.1 to 20 wt %) Ni-(0.1 to 25 wt %) Zn, the composition range of Cu—Ni—Si is (0.1 to 20 wt %) Ni-(0.1 to 15wt %) Si, the composition range of Cu—Ni—Sn is (0.1 to 20 wt %) Ni-(0.1 to 15 wt %) Sn, the composition range of Cu—Ni—Si—Sn is (0.1 to 20 wt %) Ni-(0.1 to 15 wt %) Si-(0.1 to 15 wt %) Sn, and the balance of the respective alloys is Cu containing inevitable impurities.

In the copper alloy Cu(A), Zn, Al, Ni, Si and Sn that are added to a Cu matrix and alloyed improve corrosion resistance, abrasion resistance and strength of the copper alloy.

More specifically, Ni is added to a Cu matrix and alloyed, thereby enhancing corrosion resistance, abrasion resistance and strength of the copper alloy. When the amount of Ni added exceeds the upper limit, disadvantageously, a melting point of the alloy increases and preparation costs increase.

Zn improves corrosion resistance and abrasion resistance of copper alloys and reduces a melting point of Cu alloy when used in conjunction with Ni. When Zn alone is added to a Cu matrix, in a case in which the amount of Zn added exceeds 35 wt %, disadvantageously, corrosion resistance and abrasion resistance of the prepared copper alloy are deteriorated due to use of excessive amounts of Zn and conductivity is excessively decreased, and when Zn and Ni are added to a Cu matrix and alloyed, in a case in which the added amount exceeds 25 wt %, disadvantageously, the same problems may occur.

Al, Si and Sn improve corrosion resistance, abrasion resistance and strength of copper alloys. When the amounts of the metals exceed respective upper limits, disadvantageously, conductivity is rapidly decreased, harmful reaction phases are generated at the contact interface with the other copper alloy Cu(B) and physical properties of finally prepared copper alloys may be deteriorated.

In addition, when the amounts of respective components are lower than respective lower limits, there is a risk that the intended purposes of the addition of the respective components cannot be obtained. That is, the lower limits of respective components are minimal amounts to stably accomplish the intended purposes of addition of respective components that contribute to the copper alloy.

In addition, regarding the copper alloy Cu(B), preferably, the composition range of Cu—Cr is 0.01 to 15 wt % Cr, the composition range of Cu—Zr is 0.01 to 5 wt % of Zr, the composition range of Cu—Ag is 0.01 to 25 wt % of Ag, the composition range of Cu—Mg is 0.001 to 5 wt % of Mg, the composition range of Cu—Cr—Zr is Cu—Cr(0.01 to 15 wt %)-Zr(0.01 to 5 wt %) and the balance of the respective alloys is Cu containing inevitable impurities.

In the copper alloy Cu(B), Cr, Zr, Ag and Mg that are added to a Cu matrix and alloyed improve strength of the copper alloy without deteriorating conductivity.

When the amounts of Cr, Zr, Ag and Mg exceed the upper limits, conductivity may be disadvantageously deteriorated, and when the amounts of respective components are below the lower limits, there is a risk that the strength cannot be obtained. That is, the lower limits of respective components are minimal amounts to stably accomplish the intended purposes of respective components that contribute to the copper alloy.

In addition, the present invention provides a method for producing copper alloys that can exhibit high strength, high elasticity, high corrosion resistance, abrasion resistance and high conductivity. In one embodiment, the method comprises:

(a) preparing one copper alloy Cu(A) selected from the group consisting of Cu—Zn, Cu—Al, Cu—Ni—Zn, Cu—Ni—Si, Cu—Ni—Sn and Cu—Ni—Si—Sn, or a molten alloy thereof;

(b) preparing one copper alloy Cu(B) selected from the group consisting of Cu—Cr, Cu—Zr, Cu—Ag, Cu—Mg and Cu—Cr—Zr, or a molten alloy thereof; and

(c) laminating the copper alloy Cu(A) and the copper alloy Cu(B) in the form of a di- or multi-layer, followed by bonding, or casting a molten alloy of the copper alloy Cu(A) and a molten alloy of the copper alloy Cu(B) in parallel such that a joint interface between these alloys is present.

The properties and composition range of respective alloys constituting the copper alloy Cu(A) and the copper alloy Cu(B) have been described above and a detailed explanation thereof will be omitted. In addition, preparation of the copper alloy Cu(A) selected from the group consisting of Cu—Zn, Cu—Al, Cu—Ni—Zn, Cu—Ni—Si, Cu—Ni—Sn and Cu—Ni—Si—Sn, and the copper alloy Cu(B) selected from the group consisting of Cu—Cr, Cu—Zr, Cu—Ag, Cu—Mg and Cu—Cr—Zr may be prepared using established production methods or newly designed methods and a detailed explanation thereof will thus also be omitted.

In step (c), the copper alloy Cu(A) is bonded to the copper alloy Cu(B), the bonding between the copper alloy Cu(A) and the copper alloy Cu(B) may be performed after laminating the copper alloy Cu(A) and the copper alloy Cu(B) in the form of a bi- or multi-layer and then adhering these alloys to each other, or casting a molten alloy of the copper alloy Cu(A) and a molten alloy of the copper alloy Cu(B) in parallel.

The bonding of the laminated copper alloy Cu(A) and copper alloy Cu(B) may be carried out using any well-known method. That is, the bonding of the copper alloy Cu(A) and the copper alloy Cu(B) may be carried out by resistance seam welding, roll bonding, extrusion bonding, drawing bonding, explosive bonding, partial melting, laser welding, high pressure torsioning (HPT), friction welding, diffusion bonding and the like.

In addition, casting the molten copper alloy Cu(A) and the molten copper alloy Cu(B) in parallel is preferably carried out by injecting respective molten metals in parallel, and a hybrid copper alloy is formed by bonding the same in a semi-liquid phase and solidification. A process for forming an alloy using molten metal is well-known and a detailed explanation thereof is thus omitted.

When resistance seam welding is used, great current is applied in a state in which pressure is applied to the laminated material. At this time, heat is generated by contact resistance generated at the surface at which the copper alloy Cu(A) contacts the copper alloy Cu(B) and specific resistances of the copper alloy Cu(A) and the copper alloy Cu(B), the generated heat enables the copper alloy Cu(A) and the copper alloy Cu(B) to melt and the applied pressure enables bonding therebetween.

When roll bonding or extrusion bonding is used, the copper alloy Cu(A) and the copper alloy Cu(B) may be bonded and processed in various forms such as a plate, rod, pipe or bar by passing the copper alloys between two rotating rolls or through an extrusion die at a high temperature or room temperature using deformation processing of metals.

When explosive bonding is used, the copper alloy Cu(A) and the copper alloy Cu(B) may be bonded to each other using a small amount of gunpowder. Explosive bonding is used for welding of different materials, as high melting point materials, clad welding, multilayer welding and the like. The alloy used for explosive welding has a mechanically strong bonding surface, is almost unaffected by heat in a region adjacent to the bonding surface and does not undergo deterioration in strength of parent materials in thermal treatment materials or processed curing materials.

When laser welding is used, welding is performed by condensing laser beam and thereby improving energy density, while melting the copper alloy Cu(A) and the copper alloy Cu(B). Laser welding is a bonding method in which the effect of heat on materials is low due to high energy density and enables dense welding.

When high pressure torsioning is used, bonding due to severe plastic deformation and pressure is possible by rotating the copper alloy Cu(A) and the copper alloy Cu(B) while applying high pressure thereto. When high pressure torsioning is used, the strength of bonded material is increased due to high plasticity and bonding is possible even at room temperature.

When friction welding is used, relative inter-rotation occurs in a state in which pressure is applied to the surface on which the copper alloy Cu(A) contacts the copper alloy Cu(B). At this time, when a bonding part is heated to an appropriate temperature by friction heating, an applied pressure is increased and the copper alloy Cu(A) is bonded to the copper alloy Cu(B).

When diffusion bonding is used, heating is performed in a state in which pressure is applied to the laminate to bond the copper alloy Cu(A) to the copper alloy Cu(B) through diffusion. Diffusion bonding is performed by setting subjects to be bonded by applying a pressure in a state in which they face each other in the same manner as in friction welding, and heating the same in the temperature range between a melting point to 0.3 Tm (Tm: melting point). At this time, time varies from 5 minutes to 24 hours and components having a small volume rather than components having a large volume are easy to weld without deformation of a bonded part.

Bonding by partial melting is carried out by melting parts of respective alloys and bonding the melts to the solid alloys.

In addition, the present invention may further include subjecting at least one copper alloy of the copper alloy Cu(A) and the copper alloy Cu(B) or the cast hybrid alloy to heat treatment at a temperature range of 200 to 1100° C. before step (c). Heat treatment enables the internal structure of the copper alloy Cu(A) and the copper alloy Cu(B) to be even, eliminates stress, and dissolves the second-phase particles into solid solution. When the temperature at which heat treatment is performed is below the lower limit, disadvantageously, sufficient solid solutioning of the second-phase particles present in the copper alloy cannot be achieved and the effect of heat treatment cannot be sufficiently obtained. When the temperature of heat treatment exceeds the upper limit, the copper alloy may disadvantageously melt.

In addition, the present invention, after step (c), may further include aging the hybrid copper alloy obtained by laminating and bonding the copper alloy Cu(A) and the copper alloy Cu(B), or the hybrid copper alloy obtained by casting a molten alloy of the copper alloy Cu(A) and a molten alloy of the copper alloy Cu(B) in parallel at a temperature of 25 to 650° C. When the aging temperature is below the lower limit, the effects of aging reinforcement and electrical conductivity improvement obtained by formation of the precipitated materials are disadvantageously not efficient. When the aging temperature exceeds the upper limit, precipitated particles are grown significantly or dissolved into solid solution on a Cu matrix, and, disadvantageously, the effects of aging reinforcement and conductivity enhancement may not be thus obtained.

The present invention will be described with reference to the following examples and experimental examples in more detail.

### EXAMPLE

### Production of Copper Alloy with High Strength, High Corrosion Resistance, High Elasticity, Abrasion Resistance and High Conductivity

Hybrid copper alloys having different compositions were prepared. The prepared hybrid copper alloys had a tri-layer structure such as Cu(A)-Cu(B)-Cu(A) and the details of alloy composition are shown in Table 1.

First, Examples 1 to 3, the copper alloy Cu(A) and the copper alloy Cu(B) having the composition and composition range set forth in Table 1 were first prepared by a typical casting method, the alloys were laminated in the form of Cu(A)-Cu(B)-Cu(A), and the laminate was subjected to heat treatment at 900° C. for one hour.

Then, the heat-treated laminate was bonded by roll bonding. The finally bonded material was aged at 250° C. for one hour to produce a copper alloy.

The thickness of the copper alloy was 10 mm, the thickness of Cu(A) was 2 mm and the thickness of Cu(B) was 6 mm.

Then, in Example 4, copper alloys were prepared by casting a molten alloy of the copper alloy Cu(A) and a molten alloy of the copper alloy Cu(B) in parallel such that the joint interface between these alloys was present under the conditions that they had the same composition and composition range as in Example 1. The thickness of the produced copper alloys, heat treatment and aging were the same as in Examples 1 to 3.

### COMPARATIVE EXAMPLE

Cu—Cr alloys, Cu—Ag alloys and Cu—Zr alloys commonly known as copper alloys with high conductivity and high strength were determined as Comparative Examples. The composition of the respective alloys are described in the following Table 1, the thickness of alloys was set to 10 mm, and heat treatment and aging were performed in the same manner as in the example.

That is, copper alloys having a composition and described in the following Table 1 were prepared by a common casting method, were subjected to heat treatment at 90˜1000° C. for one hour in the same manner as in Examples and aged at 300˜450° C. for one hour, to produce copper alloys of the Comparative Examples.

TABLE 1

| | Composition (wt %) |
|---|---|
| Ex. 1 | Cu—19.5Ni—13.65Zn/Cu—0.15Zr/ |
| | Cu—19.5Ni—13.65Zn |
| Ex. 2 | Cu—19.5Ni—13.65Zn/Cu—1Cr/ |
| | Cu—19.5Ni—13.65Zn |
| Ex. 3 | Cu—1.8Ni—0.3Si—0.3Sn/Cu—1Ag/ |
| | Cu—1.8Ni—0.3Si—0.3Sn |
| Ex. 4 | Cu—19.5Ni—13.65Zn/Cu—0.15Zr/ |
| | Cu—19.5Ni—13.65Zn |
| Comp. Ex. 1 | Cu—0.15Zr |
| Comp. Ex. 2 | Cu—1Ag |
| Comp. Ex. 3 | Cu—1Cr |

### TEST EXAMPLE

The electrical conductivity, strength, hardness, elasticity, oxidation rate and seawater corrosion rate of copper alloys produced in the example and comparative Example were measured and were shown in Table 2. In the following Table 1, IACS represents International Annealed Copper Standard, and is a measure of electrical conductivity that represents electricity of pure annealed copper at 20° C. in terms of 100% IACS. Strength and elasticity were based on ASTM E8-00 and hardness was based on ASTM D792. An increase in oxide weight was obtained under the condition of 800° C. and seawater corrosion rate was a value measured using seawater collected from Deacheon, Korea.

TABLE 2

| | | | | | Increase | |
|---|---|---|---|---|---|---|
| | Electrical | | | | in oxide | Seawater |
| | conduc- | | Hard- | Elas- | weight, | corrosion |
| | tivity | Strength | ness | ticity | 50 hours | rate |
| | (IASC %) | (Mpa) | (HRB) | (GPa) | (mg/cm²) | (mm/day) |
| Ex. 1 | 95 | 680 | 150 | 120 | 5.7 | 9 × 10⁻⁸ |
| Ex. 2 | 88 | 700 | 150 | 120 | 5.7 | 9.1 × 10⁻⁸ |
| Ex. 3 | 97 | 630 | 120 | 122 | 5.8 | 9.2 × 10⁻⁸ |
| Ex. 4 | 95 | 675 | 150 | 118 | 5.7 | 9 × 10⁻⁸ |
| Comp. | 97 | 450 | 65 | 110 | 11.8 | 2.3 × 10⁻⁶ |
| Ex. 1 | | | | | | |
| Comp. | 98 | 400 | 55 | 112 | 11.2 | 9.8 × 10⁻⁷ |
| Ex. 2 | | | | | | |
| Comp. | 90 | 460 | 65 | 112 | 10.3 | 1.2 × 10⁻⁶ |
| Ex. 3 | | | | | | |

As can be seen from the results of Table 2, copper alloys of the example exhibited substantially similar electrical conductivity, as compared to copper alloys of comparative example, but exhibited considerably superior strength, hardness, elasticity, oxidation resistance and seawater corrosion resistance. That is, the copper alloys according to the present invention exhibited high strength, high corrosion resistance, abrasion resistance, high elasticity and high conductivity.

In addition, it can be seen that there is no difference between Example 1 in which copper alloys were first prepared, laminated and bonded to produce copper alloys, and Example 4 in which copper alloys were produced using respective molten copper alloys.

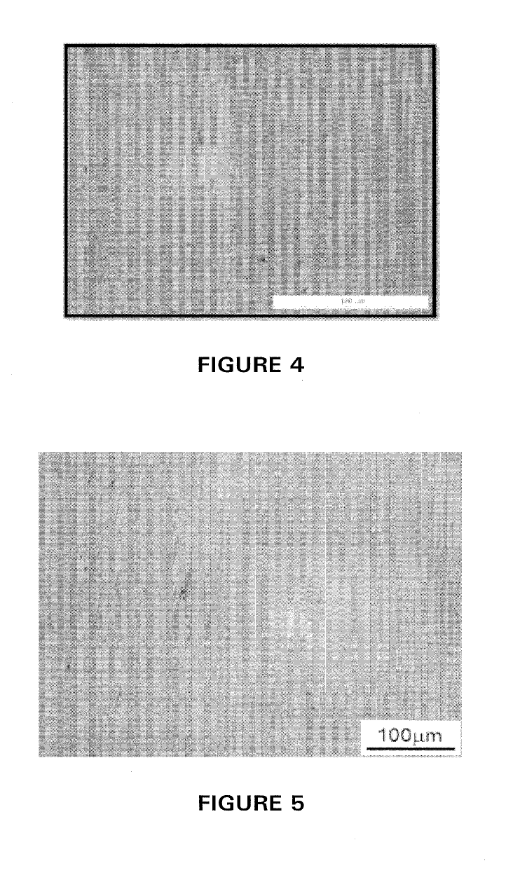

FIG. 4 is an image showing a bonding surface of the copper alloy produced in Example 1 (×200), and FIG. 5 is an image showing a bonding surface of copper alloy produced in Example 4 (×200). As can be seen from FIGS. 4 and 5, in the copper alloys according to the present invention, deteriorative reaction products or intermetallic phase were not formed at the bonding interface thereof.

As apparent from the above description, the present invention provides hybrid copper alloys that can exhibit high strength, high elastic modulus, high corrosion-resistance, wear resistance, and high conductivity by bonding two types of copper alloys in which a variety of metallic elements are selectively added to a copper matrix.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A hybrid copper alloy in which (A) a copper alloy Cu (A) selected from the group consisting of Cu—Zn, Cu—Al, Cu—Ni—Zn, Cu—Ni—Si, Cu—Ni—Sn is bonded to a copper alloy Cu (B) selected from the group consisting of Cu—Cr, Cu—Zr, Cu—Ag, Cu—Mg and Cu—Cr—Zr in the form of a bi- or multi-layer.

2. The hybrid copper alloy according to claim 1, wherein, in the copper alloy Cu (A), the composition range of Cu—Zn is 0.1 to 35 wt % of Zn, the composition range of Cu—Al is 0.1 to 20 wt % of Al, the composition range of Cu—Ni—Zn is (0.1 to 20 wt %)Ni-(0.1 to 25 wt %) Zn, the composition range of Cu—Ni—Si is (0.1 to 20 wt %)Ni-(0.1 to 15 wt %) Si, the composition range of Cu—Ni—Sn is (0.1 to 20 wt %)Ni-(0.1 to 15 wt %) Sn, the composition range of Cu—Ni—Si—Sn is (0.1 to 20 wt %)Ni-(0.1 to 15 wt %) Si-(0.1 to 15 wt %) Sn, and the balance of the respective alloys is Cu containing inevitable impurities, and
in the copper alloy Cu(B), the composition ratio of Cu—Cr is 0.01 to 15 wt % Cr, the composition ratio of Cu—Zr is 0.01 to 5 wt % of Zr, the composition ratio of Cu—Ag is 0.01 to 25 wt % of Ag, the composition ratio of Cu—Mg is 0.001 to 5 wt % of Mg, the composition ratio of Cu—Cr—Zr is (0.01 to 15 wt %)Cr-(0.01 to 5 wt %) Zr and the balance of the respective alloys is Cu containing inevitable impurities.

3. A method for producing a copper alloy comprises:
(a) preparing one copper alloy Cu(A) selected from the group consisting of Cu—Zn, Cu—Al, Cu—Ni—Zn, Cu—Ni—Si, Cu—Ni—Sn and Cu—Ni—Si—Sn, or a molten alloy thereof;
(b) preparing one copper alloy Cu(B) selected from the group consisting of Cu—Cr, Cu—Zr, Cu—Ag, Cu—Mg and Cu—Cr—Zr, or a molten alloy thereof; and
(c) laminating the copper alloy Cu(A) and the copper alloy Cu(B) in the form of a bi- or multi-layer, followed by bonding, or casting a molten alloy of the molten copper alloy Cu(A) and a molten alloy of the molten copper alloy Cu(B) in parallel such that a joint interface between these alloys is present.

4. The method according to claim 3, wherein, in the copper alloy Cu (A), the composition range of Cu—Zn is 0.1 to 35 wt % of Zn, the composition range of Cu—Al is 0.1 to 20 wt % of Al, the composition range of Cu—Ni—Zn is (0.1 to 20 wt %)Ni-(0.1 to 25 wt %) Zn, the composition range of Cu—Ni—Si is (0.1 to 20 wt %)Ni-(0.1 to 15 wt %) Si, the composition range of Cu—Ni—Sn is (0.1 to 20 wt %)Ni-(0.1 to 15 wt %) Sn, the composition range of Cu—Ni—Si—Sn is (0.1 to 20 wt %)Ni-(0.1 to 15 wt %) Si-(0.1 to 15 wt %) Sn, and the balance of the respective alloys is Cu containing inevitable impurities, and
in the copper alloy Cu(B), the composition ratio of Cu—Cr is 0.01 to 15 wt % of Cr, the composition ratio of Cu—Zr is 0.01 to 5 wt % of Zr, the composition ratio of Cu—Ag is 0.01 to 25 wt % of Ag, the composition ratio of Cu—Mg is 0.001 to 5 wt % of Mg, the composition ratio of Cu—Cr—Zr is (0.01 to 15 wt %)Cr-(0.01 to 5 wt %) Zr and the balance of the respective alloys is Cu containing inevitable impurities.

5. The method according to claim 4, further comprising:
subjecting at least one copper alloy of the copper alloy Cu(A) and the copper alloy Cu(B) or the cast hybrid copper alloy to heat treatment at a temperature range of 200 to 1100° C., before step (c).

6. The method according to claim 4, further comprising:
aging the hybrid copper alloy obtained by laminating and bonding the copper alloy Cu(A) and the copper alloy Cu(B), or the hybrid copper alloy obtained by casting the molten copper alloy Cu (A) and the molten copper alloy Cu(B) in parallel at a temperature of 25 to 650° C., after step (c).
